(19) United States
(12) Patent Application Publication
(10) Pub. No.: US 2005/0117026 A1
(43) Pub. Date: Jun. 2, 2005

(54) Automatic image quality adjustment according to size of subject

(76) Inventors: Takahiko Koizumi, Nagano-ken (JP); Ikuo Hayaishi, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 10/716,199

(22) Filed: Nov. 17, 2003

(30) Foreign Application Priority Data
Nov. 18, 2002 (JP) 2002-333844

(51) Int. Cl. H04N 5/228

(52) U.S. Cl. 348/222.1

(57) ABSTRACT

The image output device performs image processing using image data produced by an image producing device, and image production record information which includes at least information relating to the shooting conditions at the time of production of the image data, and which is associated with the image data. This output device outputs the image following processing. The image output device comprises an image quality adjuster and an output unit. The image quality adjuster determines a size parameter value that relates to the size of the subject in the image based on either the image data or the image production record information, or both, and performs color balance adjustment processing of the image data based on the size parameter value.

### BACKGROUND OF THE INVENTION

1. Field of the Invention

The present invention relates to an image quality adjustment technique for adjusting the quality of image data.

2. Description of the Related Art

The image quality of image data produced by digital still cameras (DSC), digital video cameras (DVC) and the like can be arbitrarily adjusted by using an image retouch application on a personal computer. Such an image retouch application generally has an image adjustment function that automatically adjusts the image quality of image data; if this image adjustment function is utilized, the image quality of the images that are output from the output device can be improved. For example, CRTs, LCDs, printers, projectors, television receivers and the like are known as image output devices.

Furthermore, printer drivers that control the operation of printers that constitute one type of output device also have a function that automatically adjusts the image quality; the image quality of printed images can also be improved by utilizing such printer drivers.

In images, regions that have colors that are peculiar to the subject of imaging are especially easily noticeable. For example, such regions that are easily noticeable include regions of human flesh color in portrait images that are obtained by imaging persons as the subject of imaging (the colors of such regions that are easily noticed by the human eye are called memory colors). If the coloring, i.e., hue of such regions is reproduced as a hue that is felt to be desirable by the user, the user recognizes that this image has a high image quality. The colors of image data are influenced by the color of the light source used and the characteristics of the image producing device; accordingly, depending on these shooting conditions, there may be cases in which image data with a greatly biased hue is produced. Consequently, methods are used in which the image quality is improved by adjusting the coloring of the image data, i.e., by performing color balance adjustment processing that adjusts the bias of the hue.

The size of the subject of imaging in the image (i.e., the proportion of the subject of imaging) depends on the distance between the subject of imaging and the camera, the zoom magnification and the like. If the size of the subject of imaging in the image is different, there may be cases in which the impression received by an observer differs considerably even if the same color balance adjustment is performed. Conventionally, however, no method has been devised to handle such color balance adjustment processing that takes the size of the subject of imaging into account.

### SUMMARY OF THE INVENTION

It is an object of the present invention to perform an appropriate color balance adjustment that takes into account the size of the subject of imaging within the image.

In one aspect of the present invention, there is provided a device which outputs an image using image data produced by an image producing device, and image production record information which includes at least information relating to the shooting conditions at the time of production of the image data, and which is associated with the image data. This device comprises an image quality adjuster and an output unit. The image quality adjuster can determine a size parameter value that relates to the size of the subject of imaging in the image based on either the image data or the image production record information, or both, and can perform color balance adjustment processing of the image data based on the size parameter value.

In this image output device, color balance adjustment processing based on a size parameter that relates to the size of the subject of imaging in the image data can be performed; accordingly, the image quality can be appropriately adjusted in accordance with the size of the subject of imaging.

The present invention can be realized in various aspects. For example, the present invention can be realized in aspects such as an image output method and image output device, an image data processing method and image data processing device, a computer program used to realize the functions of these methods or devices, a recording medium on which such a computer program is recorded, and data signals in which such a computer program is realized in a carrier wave.

The above and other objects, characterizing features, aspects and advantages of the present invention will be clear from the description of preferred embodiments presented below along with the attached figures.

### BRIEF DESCRIPTION OF THE DRAWINGS

FIG. 1 is an explanatory diagram which shows one example of the image output system.

FIG. 2 is a block diagram which shows the schematic construction of the digital still camera.

FIG. 3 is an explanatory diagram which shows one example of the internal construction of the image file in conceptual form.

FIG. 4 is an explanatory diagram which shows one example of the data structure of the attribute information storage field.

FIG. 5 is an explanatory diagram which shows one example of the data structure of the Exif data field.

FIG. 6 is a schematic structural diagram of the printer.

FIG. 7 is a block diagram which shows the construction of the printer.

FIG. 8 is a flow chart which shows the image processing routine.

FIG. 9 is a flow chart which shows the image quality adjustment processing.

FIG. 10 is an explanatory diagram which shows the tone value adjustment processing.

FIGS. 11(a) through 11(d) are explanatory diagrams which show the processing amount of the color balance adjustment.

FIG. 12 is an explanatory diagram which shows the relationship between the value of hue H and color.

FIGS. 13(a) through 13(d) are explanatory diagrams which show another embodiment of the color balance adjustment processing.

FIG. 14 is a flow chart which shows another embodiment of the image quality adjustment processing.

FIGS. 15(a) and 15(b) are explanatory diagram which show the difference and tone value adjustment processing.

FIGS. 16(a) through 16(c) are explanatory diagrams which show the relationship between the proportion of the amount of processing and the size parameter value.

FIG. 17 is a flow chart which shows another embodiment of the image quality adjustment processing.

FIG. 18 is a flow chart which shows another embodiment of the image quality adjustment processing.

FIG. 19 is an explanatory diagram which shows one example of the image output system.

### DESCRIPTION OF THE PREFERRED EMBODIMENTS

Next, aspects of the present invention will be described in the following order on the basis of embodiments:
A. Construction of Image Output System
B. Construction of Image Producing Device
C. Construction of Image File
D. Construction of Image Output Device
E. Image Processing
F. Construction of Image Output System Using Image Data Processing Device
G. Modifications

A. Construction of Image Output System

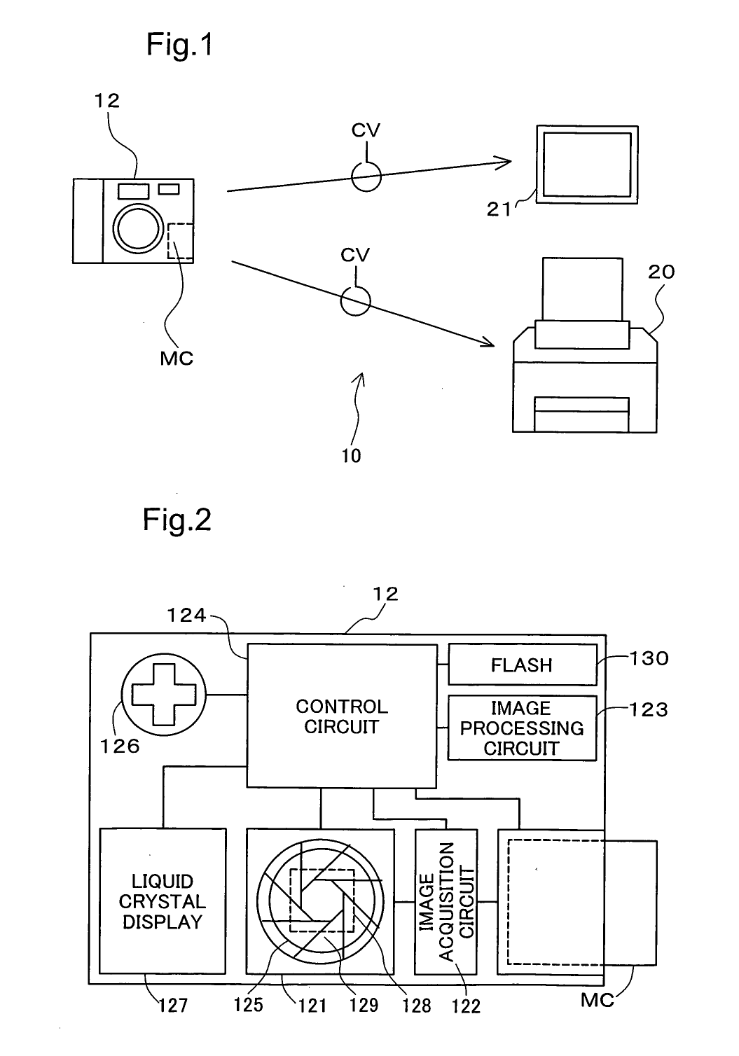

FIG. 1 is an explanatory diagram which shows one example of an image output system to which an output device constituting one embodiment of the present invention can be applied. The image output system 10 comprises a digital still camera 12 used as an image producing device that produces an image file, and a printer 20 used as an output device for images. The image file that is produced in the digital still camera 12 is sent to the printer 20 via a cable CV, or by directly inserting a memory card MC on which the image file is stored into the printer 20. The printer 20 performs image quality adjustment processing of the image data on the basis of the read-in image file, and outputs images. Besides a printer 20, a monitor 21 such as a CRT display, LCD display or the like, or a projector or the like, may be used as the output device. Below, a case will be described in which a printer 20 comprising an image quality adjuster and an image output unit is used as an output device, and a memory card MC is directly inserted into the printer 20.

B. Construction of Image Producing Device

FIG. 2 is a block diagram which shows the schematic construction of the digital still camera 12. The digital still camera 12 of this embodiment comprises an optical circuit 121 which is used to collect optical information, an image acquisition circuit 122 which is used to acquire an image by controlling the optical circuit, an image processing circuit 123 which is used to process the acquired digital image, a flash 130 which is used as an auxiliary light source, and a control circuit 124 which controls the various circuits. The control circuit 124 comprises a memory (not shown in the figures). The optical circuit 121 comprises a lens 125 which gathers optical information, an aperture 129 which adjusts the amount of light, and a CCD 128 which converts the optical information passing through the lens into image data.

The digital still camera 12 stores the acquired images on a memory card MC. The storage format of the image data in the digital still camera 12 is generally the JPEG format; however, storage formats such as the TIFF format, GIF format, BMP format, RAW data format or the like may also be used.

The digital still camera 12 also comprises a selection/determination button 126 which is used to set various shooting conditions (aperture value, shooting mode and the like), and a liquid crystal display 127. The liquid crystal display 127 is used to preview the acquired images, and is also used in the setting of the shooting mode and the like using the selection/determination button 126.

In cases where imaging is performed in the digital still camera 12, image data and image production record information are stored on the memory card MC as an image file. The image production record information may include the set values of parameters relating to the shooting conditions at the time of shooting (at the time of image data production); for example, this information may include the set values of parameters that can be arbitrarily set such as the shooting mode at the time of shooting and the like, the set values of parameters that are used in image production such as the aperture value, shutter speed and the like, and the set values of parameters that are automatically set such as the maker name and the like. The shooting mode can be selected from a plurality of preset modes such as the standard mode, portrait mode, scenery mode, night scene mode and the like. In cases where one of these modes is designated, the associated parameters (aperture value, shutter speed and the like) are automatically set in accordance with the designated shooting mode. For example, in a case where the portrait mode is selected as the shooting mode, the parameters associated with image data production are set at values that are suitable for portrait images.

C. Construction of Image File

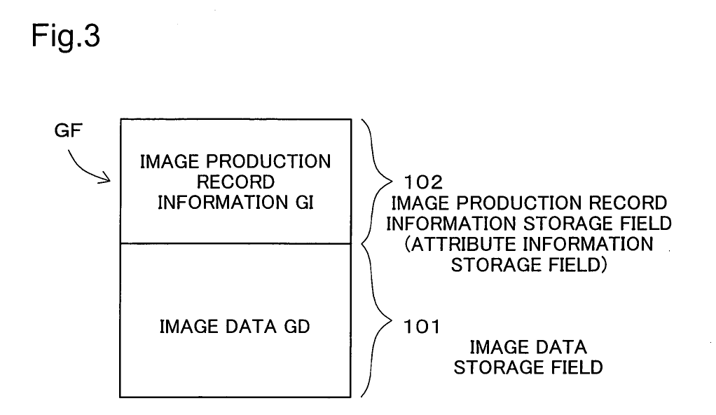

FIG. 3 is an explanatory diagram which schematically shows one example of the internal construction of an image file that can be used in the present embodiment. The image file GF comprises an image data storage field 101 that stores image data GD, and an image production record information storage field 102 that stores image production record information GI. For example, the image data GD is stored in the JPEG format, and the image production record information GI is stored in the TIFF format (the data and data fields are in formats specified using tags). Furthermore, the terms “file structure” and “data structure” used in the present embodiment refer to the structure of the file or data in the state in which the file or data is stored in the memory device.

The image file GF in the present embodiment may basically comprise the abovementioned image data storage field 101 and image production record information storage field 102, and may have a file structure conforming to a file format that has already been standardized. Below, a case will be described in which the data file GF of the present embodiment conforms to the Exif file format.

An Exif file conforms to the digital still camera image file format standard (Exif); the specifications are determined by the Japan Electronic Information Technology Association (JEITA). Furthermore, as in the case of the schematic diagram shown in FIG. 3, the Exif file format comprises a JPEG image data storage field that stores image data in the JPEG format, and an attribute information storage field that stores various types of information relating to the stored JPEG image data. The JPEG image data storage field corresponds to the image data storage field 101 in FIG. 3, and the attribute information storage field corresponds to the image production record information storage field 102. Image production record information relating to JPEG images such as the date and time of shooting, aperture value and type of light source and the like is stored in the attribute information storage field.

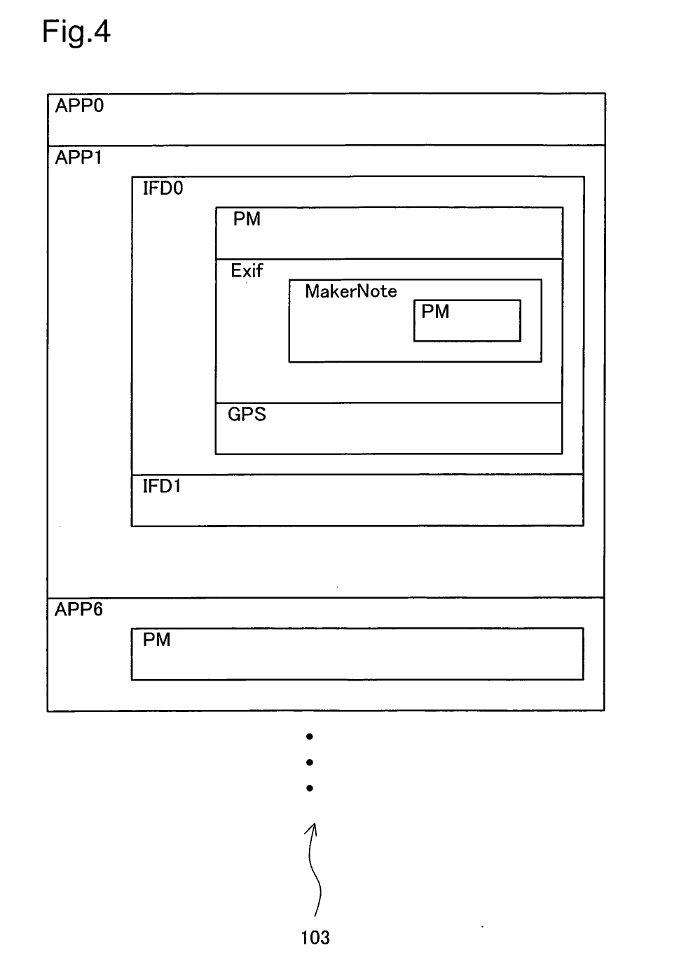

FIG. 4 is an explanatory diagram which shows an example of the data structure of the attribute information storage field 103. In the Exif file format, hierarchical tags are used in order to specify the data fields. Each data field may contain a plurality of lower-ranking data fields that are specified by lower-ranking tags. In FIG. 4, the regions surrounded by squares each express one data field, and the tag names are noted at the upper left. This embodiment includes three data fields whose tag names are APP0, APP1 and APP6. The APP1 data field contains two data fields whose tag names are IFD0 and IFD1. The IFD0 data field contains three data fields whose tag names are PM, Exif and GPS. The data and data fields are stored according to designated addresses or offset values, and a search for the addresses or offset values can be made using the tag names. Data corresponding to desired information can be acquired on the side of the output device by designating the addresses or offset values corresponding to this desired information.

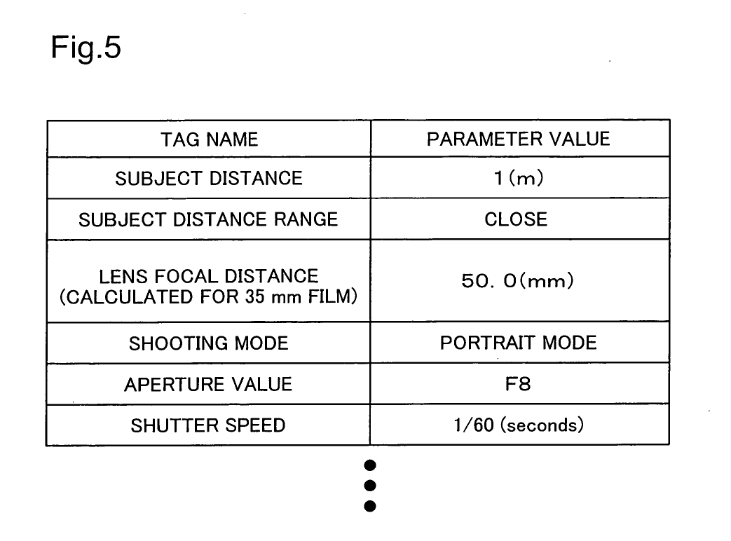

FIG. 5 is an explanatory diagram which illustrates one example of the data structure (data tag names and parameter values) of the Exif data field that can be referred to by designating the tag names in the order APP1-IFD0 Exif in FIG. 4. As is shown in FIG. 4, the Exif data field may contain a data field whose tag name is MakerNote. The MakerNote data field may further contain numerous data; however, this is not shown in FIG. 5.

As is shown in FIG. 5, parameter values relating to information such as the subject distance, subject distance range, lens focal distance (calculated for 35 mm film), shooting mode, aperture value, shutter speed and the like are stored in the Exif data field. In the present embodiment, the subject distance and subject distance range are used as subject distance information relating to the distance between the image producing device and the subject of imaging of the image data, the lens focal distance (calculated for 35 mm film) is used as lens focal distance information relating to the lens focal distance of the image producing device, and the shooting mode is used as shooting mode information relating to the operating settings of the image producing device.

The subject distance constitutes information relating to the distance between the image producing device and the subject of imaging at the time that image data is produced. For example, this is set in meter units on the basis of distance information that is set in order to adjust the focus at the time that the image data is produced.

The subject distance range constitutes information that relates to the distance between the image producing device and the subject of imaging at the time that the image data is produced; here, a distance range is set as a parameter value. For example, this distance range is set on the basis of distance information that is used in order to adjust the focus at the time that the image data is produced. For example, the distance range is selected and set from the following three distance ranges: macro (0 to 1 m), close (1 to 3 m) and distant (greater than 3 m).

The lens focal distance (calculated for 35 mm film) is a value that is obtained by converting the actual lens focal distance into the lens focal distance in a camera using 35 mm film under conditions which are such that the ratio of the size of the light-receiving element to the lens focal distance is maintained.

The shooting mode constitutes information that relates to the operating settings of the image producing device at the time that the image data is produced. The parameter value is selected from a plurality of predetermined modes, e.g., standard mode, portrait mode, scenery mode, night scene mode and the like. In cases where the parameter value of the shooting mode is “portrait mode”, it can be judged that the operating settings of the image producing device are settings that are suitable for portrait images.

The aperture value constitutes information relating to the aperture value at the time that the image data is produced. The F number is used as the parameter value in this case. Accordingly, as the aperture value increases, the aperture is smaller.

The shutter speed information is information that relates to the shutter speed at the time that the image data is produced. The units of this information are meters.

D. Construction of Image Output Device

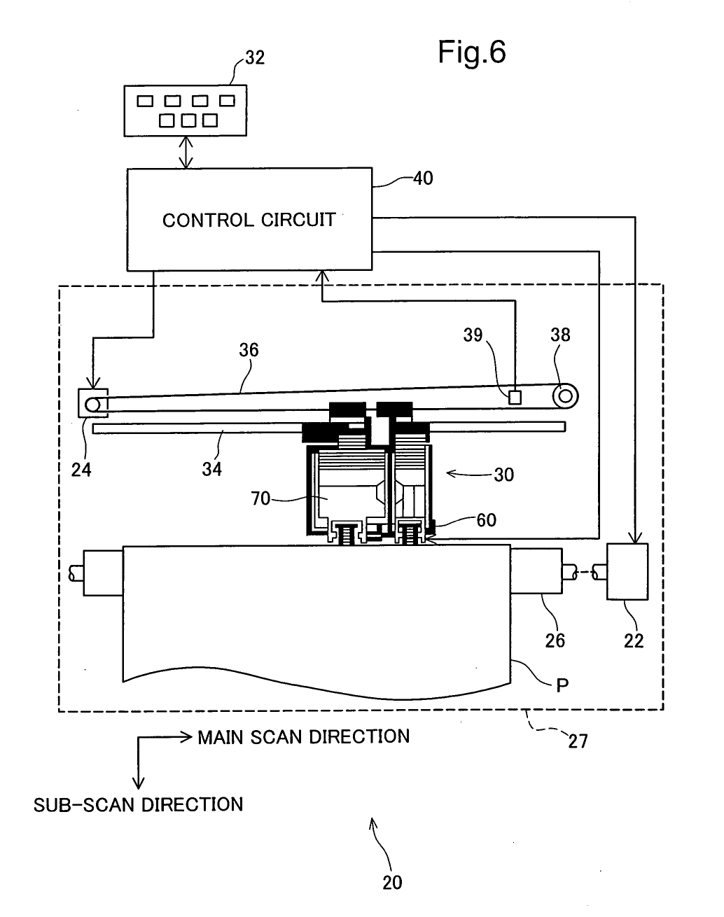

FIG. 6 is a schematic structural diagram of the printer 20. This printer 20 is a printer that can output images; for example, this printer is an ink jet printer that forms dot patterns by causing inks of four colors (cyan C, magenta Mg, yellow Y and black K) to jet onto a printing medium. Furthermore, a printer with an electrophotographic system that forms images by transferring and fixing a toner on a printing medium may also be used. In addition to the four colors mentioned above, the inks used may also include light cyan LC which has a smaller optical density than cyan C, light magenta LM which has a smaller optical density than magenta Mg, and dark yellow DY which has a deeper optical density than yellow Y. Instead of this arrangement, in the case of monochromatic printing, a construction using only black K may be used, or red R and green G may be used. The types of inks or toners used may be determined in accordance with the characteristic features of the images that are output.

As is shown in the figures, the printer 20 comprises an image output unit 27 that performs printing, an operating panel 32, and a control part 40 that can exchange signals inside the image output unit 27 with the operating panel 32. The image output unit 27 comprises a subs-scan feed mechanism which feeds the printing paper P in the sub-scan direction by means of a paper feeding motor 22, a main scan feed mechanism which causes the carriage 30 to perform a reciprocating motion in the axial direction of the platen 26 (main scan direction) by means of a carriage motor 24, and a head driving mechanism which controls the jetting of ink and dot formation by driving a printing head unit 60 that is mounted on the carriage 30. The printing head unit 60 comprises a printing head (not shown in the figures) equipped with nozzles that are used to cause jetting of the inks that can be utilized.

The sub-scan feed mechanism that conveys the printing paper P comprises a gear train that transmits the rotation of the paper feeding motor 22 to the platen 26 and paper feeding rollers (not shown in the figures). Furthermore, the main scan feed mechanism that causes the reciprocating motion of the carriage 30 comprises a sliding shaft 34 which is installed in a bridge configuration parallel to the shaft of the platen 26, and which holds the carriage 30 so that this carriage is capable of a sliding motion, a pulley 38 which mounts an endless driving belt 36 together with the carriage motor 24, and a position sensor 39 which detects the origin position of the carriage 30.

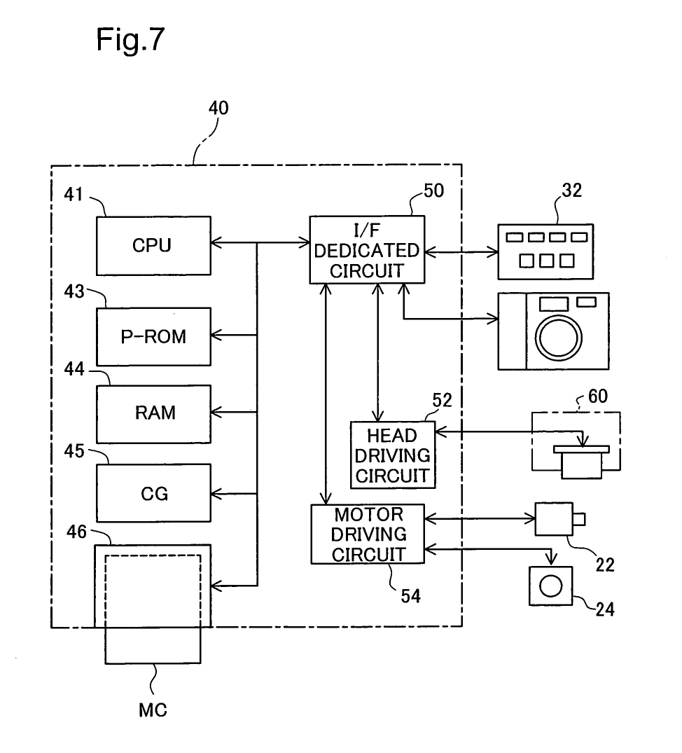

FIG. 7 is a block diagram which shows the construction of the printer 20. The control circuit 40 is constructed as an arithmetical logic operating circuit which comprises a CPU 41 that performs image quality adjustment processing, a RAM 44 that temporarily stores the calculation results of the CPU 41, image data and the like, a programmable ROM (PROM) 43 that stores data required for image quality adjustment processing such as programs for image quality adjustment processing and the like, and a character generator (CG) 45 which stores a character dot matrix. This control circuit 40 further comprises a memory card slot 46 that acquires data from a memory card MC, a dedicated I/F circuit 50 that performs a dedicated I/F function with an external motor and the like, a head driving circuit 52 which is connected to this dedicated I/F circuit 50, and which drives the printing head unit 60 so that ink is caused to jet from this unit, and a motor driving circuit 54 which drives the paper feeding motor 22 and carriage motor 24. The dedicated I/F circuit 50 further contains a universal serial bus interface circuit, and can receive data supplied from a digital still camera 12 or the like (used as an image producing device) via a cable. The circuit contained in the dedicated I/F circuit 50 is not limited to a universal serial bus interface circuit; this circuit may be determined with reference to the ease of connection with the image producing device. Furthermore, the RAM 44 functions as a buffer memory which temporarily stores raster data.

The printer 20 can acquire image data produced by the digital still camera 12 or the like (used as an image producing device) via (for example) a cable CV. Furthermore, the image producing device may store image data on a memory card MC, and the printer 20 may also have a construction that acquires image data via this memory card MC. Moreover, a construction that acquires image data via a network (not shown in the figures) may also be used.

When the image data processing program is started as a result of the insertion of a memory card MC into the memory card slot 46 or the detection of the connection of the digital still camera 12 to the dedicated I/F circuit 50 via a cable, the CPU 41 of the control circuit 40 performs image quality adjustment processing that adjusts the color balance of the image data. Specifically, the control circuit 40 functions as an image quality adjuster. The image data processing program may also have a construction that is started by an operation performed by the user. The detailed image processing that is performed by the CPU 41 will be described later.

In the printer 20 having the hardware construction described above, the printing paper P is conveyed by the paper feeding motor 22, and the carriage 30 is caused to perform a reciprocating motion by the carriage motor 24 while the printing head is driven at the same time so that respective ink droplets are caused to jet, thus forming ink dots so that images based on printing data whose image quality has been adjusted are formed on the surface of the printing paper P.

E. Image Processing

E1. Flow Chart of Image Processing

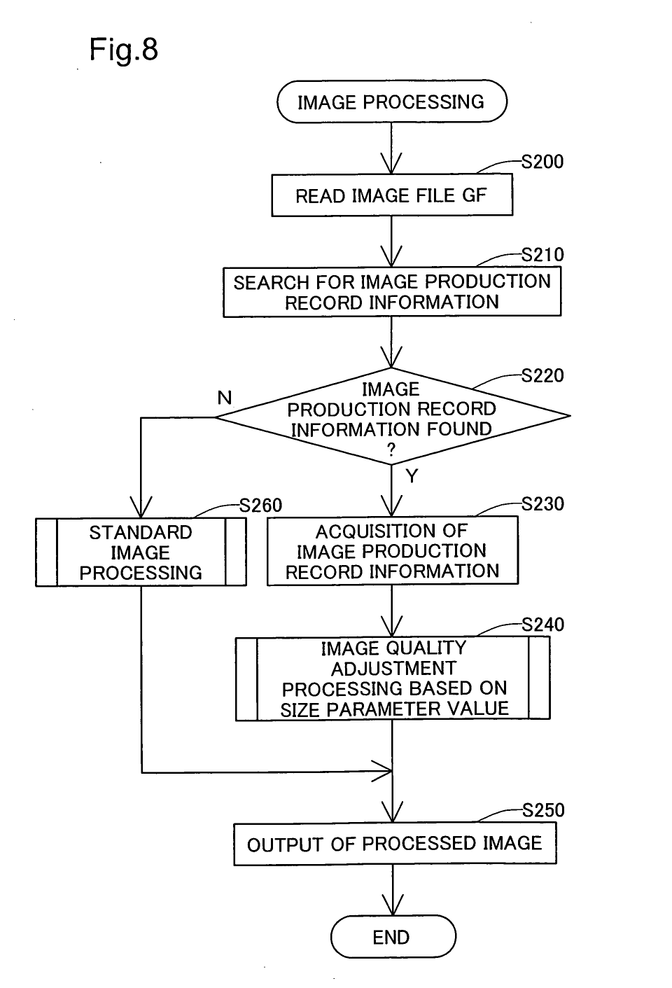

FIG. 8 is a flow chart which shows the image processing routine in the printer 20 of the present embodiment. In the following description, a case will be described in which a memory card MC on which an image file GF is stored is inserted directly into the printer 20. When a memory card MC is inserted into the memory card slot 46, the CPU 41 of the control circuit 40 (FIG. 7) of the printer 20 reads out the image file GF (FIG. 3) from the memory card MC (step S200). Next, in step S210, the CPU 41 searches for image production record information GI indicating information relating to the time at which the image data was produced from the attribute information storage field of the image file GF. In cases where image production record information GI is found (step S220: Y), the CPU 41 acquires this image production record information GI (step S230). Next, the CPU 41 performs image quality adjustment processing (described later) (step S240), and outputs the processed images (step S250), whereupon the present processing routine is ended.

On the other hand, an image file produced using a drawing application or the like does not contain image production record information GI which has information such as shooting mode information or the like. In cases where no image production record information GI can be found (step S220: N), the CPU 41 performs standard processing (step S260), and outputs the processed images (step S250), whereupon the present processing routine is ended.

E2. First Embodiment of Image Quality Adjustment Processing

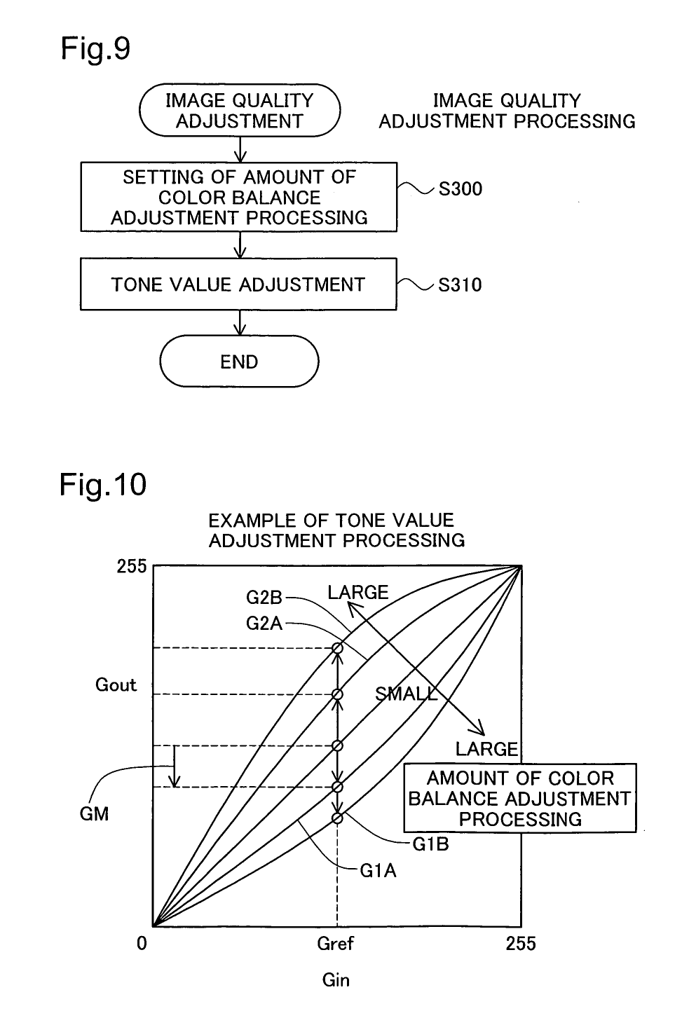

FIG. 9 is a flow chart which shows the image quality adjustment processing (corresponding to step S240 in FIG. 8) in this embodiment. In this embodiment, the CPU 41 (FIG. 7) sets the processing amount of the color balance adjustment in accordance with a size parameter value (step S300), and performs an adjustment of the tone values using the set processing amount (step S310). The color balance adjustment processing is processing that adjusts the coloring of the image data, i.e., processing that adjusts the hue. The adjustment of the tone values is performed so that the hue in regions having the characteristic color of the subject of imaging approach the desired hue. For example, a case in which images that have a person as the subject of imaging will be described. A reddish coloring is desired by the user as the coloring of human flesh color regions in portrait images. Accordingly, the quality of the image data can be improved by performing color balance adjustment processing of the image data so that red is emphasized. In this embodiment, the color balance adjustment processing is performed using the entire image as an object. The color balance of the image data can be adjusted by adjusting the respective tone values of red R, green G and blue B. In this embodiment, the tone values for G are reduced in order to adjust the color balance so that a reddish coloring is obtained. In addition to combinations of the basic colors red R, green G and blue B, various combinations of cyan C, magenta Mg, yellow Y and the like may be employed as color components used in the adjustment of the tone values.

FIG. 10 is an explanatory diagram which shows the relationship between the input level Gin and output level Gout for green G in the tone value adjustment processing of the present embodiment. The graph G1A is constructed so that the output level Gout is smaller than the input level Gin. If the tone value adjustment for green G is performed using this graph G1A, the tone values for green G can be reduced, so that the coloring of the images can be adjusted to a reddish coloring.

For example, such a graph G1A can be constructed so that the output level Gout at the adjustment input level Grefi is adjusted to a level that is smaller than the original value by an adjustment magnitude GM. The output level Gout corresponding to other input levels Gin is interpolated using a spline function. The adjustment magnitude GM is a value that can be determined on the basis of a sensory-response evaluation of the output results obtained for the images following image quality adjustment, and is a value that can be adjusted on the basis of the size parameter value (details will be described later).

The graph G1B shows the input-output relationship used in tone value adjustment processing in which the amount of color balance adjustment processing is larger than in the case of the graph G1A. Here, to say that “the amount of color balance adjustment processing is large” means that the amount of variation in the color tone values is large. In cases where the adjustment magnitude GM is large, the amount of color balance adjustment processing is also large. Accordingly, coloring of the image data can be adjusted to a greater extent by increasing the adjustment magnitude GM.

The graph G2A is constructed so that the output level Gout is larger than the input level Gin; this graph shows the input-output relationship that is used in cases where the tone values for green G are to be increased. The graph G2B shows the input-output relationship that is used in tone value adjustment processing in which the amount of color balance adjustment processing is greater than that in the case of the graph G2A. The graphs G2A and G2B are not used in cases where the red in the coloring of the image data is emphasized by reducing the tone values for green G.

In cases where tone values for color components other than green G are adjusted as well, this tone value adjustment can be accomplished by setting the relationship between the input level and output level in the same manner as in the case of green G. The amounts of adjustment of the respective color components can be determined on the basis of a sensory-response evaluation of the output results of the images following image quality adjustment. For example, color balance adjustment processing in which green G is reduced and red R is increased may be performed in order to adjust the coloring to a reddish coloring.

FIGS. 11(a) through 11(d) are explanatory diagrams which show the processing amount of the color balance adjustment in the present embodiment. The image IMG10a shown in FIG. 11(a) is an image in which a person is imaged. The image IMG10b shown in FIG. 11(b) is an image in which a person and a building are imaged. The image IMG10b differs from the image IMG10a in that the person appearing as the subject of imaging is imaged at a smaller size. Such images in which the subject of imaging is imaged at a small size are generated (for example) in cases where the distance between the image producing device and the subject of imaging at the time of image production is large (i.e., the subject distance is large), and in cases where the lens focal distance of the image producing device is small. On the other hand, in cases where the subject distance is small and cases where the lens focal distance is large, images in which the subject of imaging is imaged at a large size as in the image IMG10a are produced. Accordingly, the subject distance and lens focal distance can be used as parameter values that relate to the size of the subject of imaging. In the case of the subject distance, a larger value indicates a smaller size of the subject of imaging. In the case of the lens focal distance, a larger value indicates a larger size of the subject of imaging.

In the image quality adjustment processing of the present embodiment, the CPU 41 (FIG. 7) performs the color balance adjustment processing with a larger amount of processing in the case of images in which the size of the subject of imaging is larger, as in the image IMG10a. In order to perform such processing, the subject distance and lens focal distance are used as size parameter values that relate to the size of the subject of imaging, and the processing amount of the color balance adjustment is adjusted in accordance with these size parameter values.

FIG. 11(c) is an explanatory diagram which shows the relationship between the adjustment magnitude GM (FIG. 10) of the color balance adjustment processing and the subject distance. For example, the “subject distance information” (FIG. 5) in the abovementioned embodiment of image production record information can be used as the subject distance. The parameter value of this “subject distance information” can be acquired by analyzing the image production record information. In this example, the adjustment magnitude GM is set so that this magnitude is increased as the subject distance decreases. Accordingly, in cases where the subject distance used as a size parameter value is small, i.e., in cases where the size of the subject of imaging indicated by the size parameter value is large, the processing amount of the color balance adjustment is increased, and in cases where the subject distance is large, i.e., in cases where the size of the subject of imaging indicated by the size parameter value is small, the processing amount of the color balance adjustment is reduced.

In cases where the size of the subject of imaging is large, the size of the regions that have a color close to the characteristic color (memory color) of the subject of imaging (hereafter referred to as “memory color regions”, these are flesh color regions in the present example) is also large in most instances, so that the coloring of the memory color regions tends to be conspicuous. In such cases as well, if color balance adjustment processing is performed using a large processing amount based on the adjustment magnitude GM shown in FIG. 11(c), the color balance is adjusted so that the hue of the image data approaches a desirable hue, thus making it possible to obtain output results with a high image quality.

On the other hand, in cases where the size of the subject of imaging is small, the conspicuousness of the subject of imaging is reduced, so that both the coloring of the subject of imaging and the coloring of the background are noticed. Accordingly, if the hue of the image data is uniformly adjusted, there may be cases in which the variation in the hue of the background becomes conspicuous, so that the image quality cannot be sufficiently improved. In such cases as well, a great alteration in the coloring of the background can be suppressed by reducing the processing amount of the color balance adjustment on the basis of the adjustment magnitude GM shown in FIG. 11(c).

FIG. 11(d) is an explanatory diagram which shows the relationship between the adjustment magnitude GM (FIG. 10) of the color balance adjustment processing and the lens focal distance. For example, the “lens focal distance (calculated for 35 mm film) information” (FIG. 5) in the abovementioned embodiment of the image production record information can be used as the lens focal distance. The parameter value of this “lens focal distance information” can be acquired by analyzing the image production record information. In this example, the adjustment magnitude GM is set so that this magnitude is increased as the lens focal distance increases. Accordingly, in cases where the lens focal distance used as a size parameter value is large, i.e., in cases where the size of the subject of imaging indicated by the size parameter value is large, the processing amount of the color balance adjustment can be increased, and in cases where the lens focal distance is small, i.e., in cases where the size of the subject of imaging indicated by the size parameter value is small, the processing amount of the color balance adjustment can be reduced. Accordingly, as in the case of the abovementioned subject distance, an appropriate color balance adjustment that is suited to the size of the subject of imaging can be performed.

Furthermore, the size of the image in the image data, i.e., the enlargement rate of the image, is a value that varies not only according to the lens focal distance, but also according to the ratio of the lens focal distance to the size of the light-receiving element (or film). Accordingly, it is desirable that the size of the subject of imaging in the image data be judged using the ratio of the lens focal distance to the size of the light-receiving element (or film) of the image producing device. The parameter value of the lens focal distance (calculated for 35 mm film) information in the present embodiment is a value that is calculated beforehand with the size of the light-receiving element taken into account. Accordingly, by adjusting the processing amount of the color balance adjustment using a lens focal distance that is calculated in terms of 35 mm film, it is possible to omit processing for adjusting the processing amount on the basis of the size of the film or light-receiving element, which varies according to the image producing device.

In this embodiment, only the tone values for green G are adjusted; however, in cases where the tone values for a plurality of color components are adjusted as well, it is desirable to adjust the processing amounts for the respective color components in accordance with the subject distance or lens focal distance in the same manner as in the example shown in FIGS. 11(a)-11(d). If this is done, the hue of the image data can be adjusted so that this hue approaches a desirable hue in cases where the size of the subject of imaging is large, and a great alteration in the coloring of the background can be suppressed in cases where the size of the subject of imaging is small.

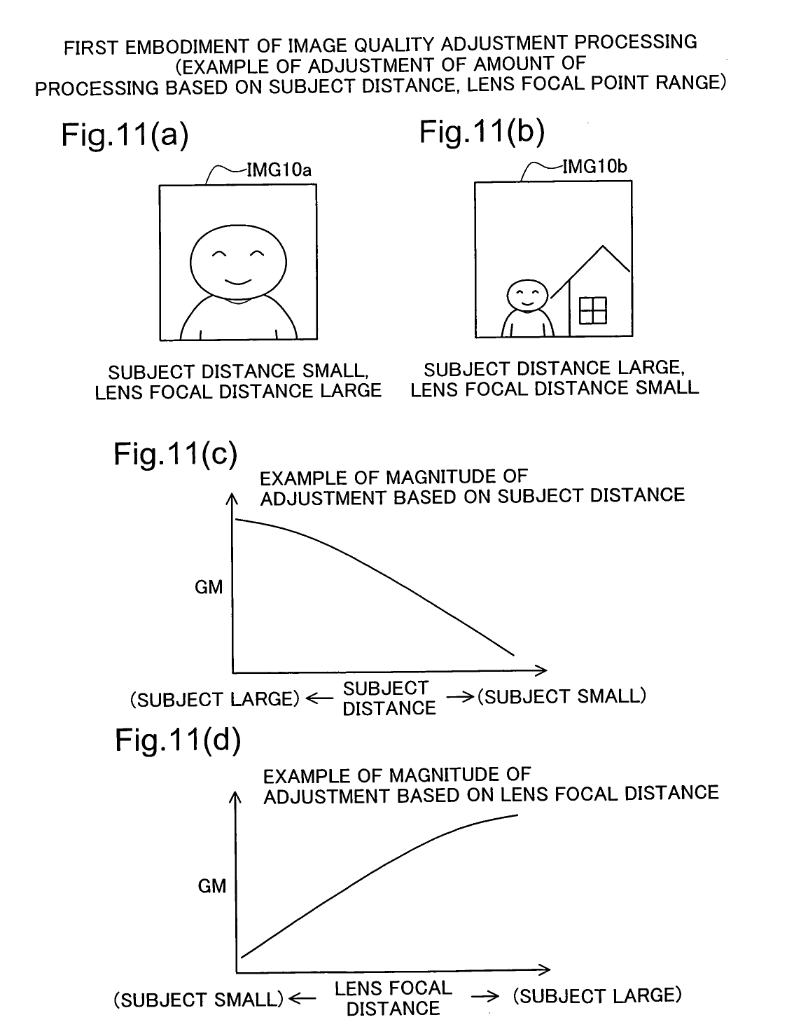

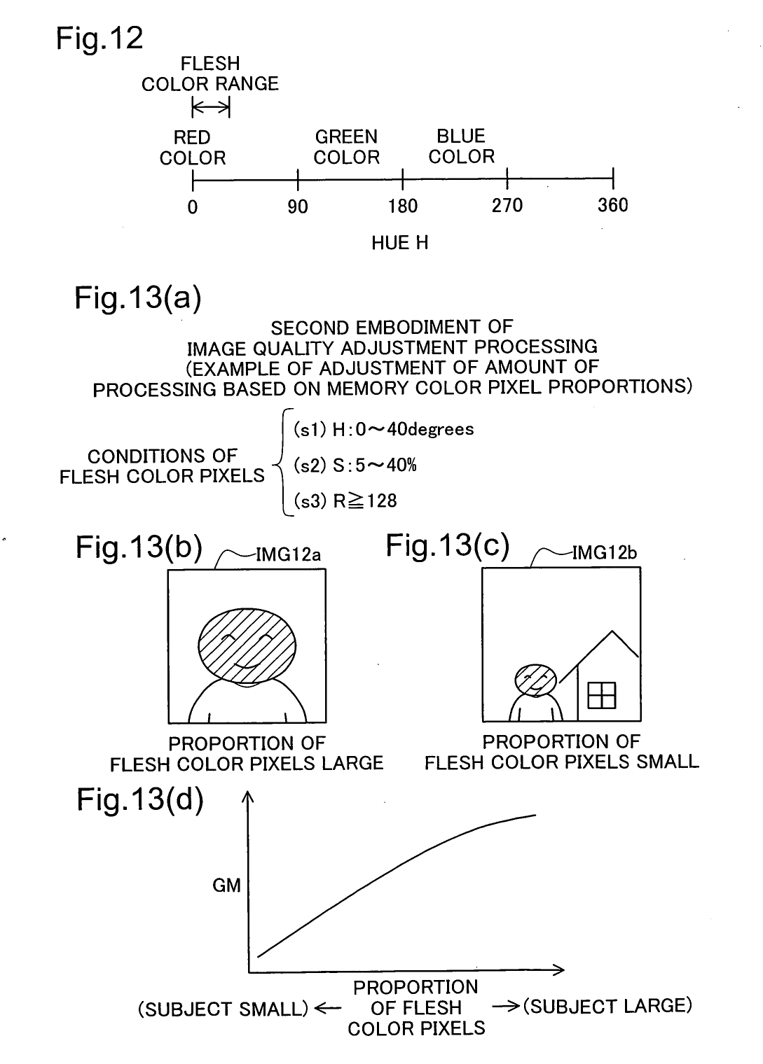

In this embodiment, color balance adjustment processing is performed for all of the pixels of the image data; however, it would also be possible to perform this adjustment only for pixels that have the characteristic color of the subject of imaging (memory color). For example, pixels that have the flesh color that is characteristic of persons as subject of imaging may be subjected to color balance adjustment processing. FIG. 12 is an explanatory diagram which shows the relationship between the value of the hue H and color. In this embodiment, the range of values that can be adopted by the hue H is 0 degrees to 360 degrees. 0 degrees indicated a red color, 120 degrees indicates a green color, and 240 degrees indicates a blue color. For example, pixels whose hue H is within the range of 0 degrees to 40 degrees can be selected as pixels that have a flesh color. If color balance adjustment processing is thus performed only for pixels that have the memory color, a great alteration in the coloring of the background can be suppressed.

Furthermore, in this case as well, as in the example shown in FIGS. 11(a)-11(d), it is desirable to adjust the processing amount of the color balance adjustment so that this amount is increased as the size of the subject of imaging indicated by the size parameter value increases. If this is done, then the hue of regions that have the memory color characteristic of the subject of imaging can be adjusted to a hue felt to be desirable by the user in cases where the size of the subject of imaging is large. On the other hand, in cases where the size of the subject of imaging is small, deterioration of the balance between the coloring of the subject of imaging and the coloring of the background caused by a great alteration in the hue of regions that have the memory color can be suppressed.

In cases where the image data is expressed in a color space that does not contain a brightness value, a hue value, and a saturation value as parameters, e.g., in cases where the image data is expressed using an RGB color space, the brightness, hue and saturation for the respective pixels can be acquired by converting this color space into a color space which contains the brightness, hue and saturation as parameters, e.g., an HLS color space, HIS color space or the like.

E3. Second Embodiment of Image Quality Adjustment Processing

FIGS. 13(a) through 13(d) are explanatory diagrams which illustrate another embodiment of color balance adjustment processing based on a size parameter value. This embodiment differs from the abovementioned first embodiment in that the proportion of the pixels that have a color close to the color that is characteristic of the subject of imaging (memory color) in the image data (i.e., the proportion of memory color pixels in the image data) is used as a size parameter value. FIG. 13(a) is an explanatory diagram which shows the conditions that are used to select pixels that have a color that is close to flesh color as the memory color pixels in a case where the flesh color of a person is used as the memory color. In this embodiment, pixels that satisfy the following three conditions are selected as memory color pixels (in this case, flesh color pixels).
(s1) The hue H is in the range of 0 to 40 degrees.
(s2) The saturation S is in the range of 5 to 40%.
(s3) The tone value for red R is 128 or greater. Here, the range of values that may be adopted by the tone value for red R is 0 to 255.

FIGS. 13(b) and 13(c) are explanatory diagram which show groups of memory color pixels, i.e., memory color regions (flesh color regions in this example), that are selected according to the abovementioned three conditions (s1) through (s3). The image IMG12a shown in FIG. 13(b) is an image in which a person is imaged. The image IMG12b shown in FIG. 13(c) is an image in which a person and a building are imaged. The image IMG12b differs from the image IMG12a in that the person constituting the subject of imaging is imaged at a small size. Furthermore, in these two images, the flesh color regions that satisfy the abovementioned three conditions are indicated by shading. In the example of these two images, the region of the person's face is indicated by shading. Furthermore, it is not necessary that the pixels used as memory color regions constitute a single region as shown in FIGS. 13(b) and 13(c); these pixels may be divided among several regions. Specifically, all pixels whose pixel values satisfy the abovementioned conditions are used as memory color regions.

In images in which the subject of imaging is imaged at a large size as in IMG12a, the proportion of the memory color regions (flesh color regions in this example), i.e., the proportion of the memory color pixels, is large. On the other hand, in the case of images in which the subject of imaging is imaged at a small size as in IMG12b, the proportion of the memory color pixels is small. Accordingly, the proportion of the memory color pixels can be used as a parameter value that relates to the size of the subject of imaging. In this case, a larger value indicates a larger size of the subject of imaging.

FIG. 13(d) is an explanatory diagram which shows the relationship between the adjustment magnitude GM (FIG. 10) of the color balance adjustment processing and the proportion of the memory color pixels. For example, the proportion of the memory color pixels can be acquired by setting conditions for the selection of pixels as memory color regions in advance, and analyzing the image data on the basis of these set conditions. For example, the abovementioned three conditions (s1) through (s3) can be used as conditions for the memory color regions (flesh color regions) in cases where a person is the subject of imaging.

In the example shown in FIG. 13(d), the adjustment magnitude GM is set so that this magnitude is increased as the proportion of the memory color pixels increases. Accordingly, in cases where the proportion of the memory color pixels used as a size parameter value is large, i.e., in cases where the size of the subject of imaging indicated by the size parameter value is large, the processing amount of the color balance adjustment can be increased, and in cases where the proportion of the memory color pixels is small, i.e., in cases where the size of the subject of imaging indicated by the size parameter value is small, the processing amount of the color balance adjustment can be reduced. Accordingly, as in the abovementioned first embodiment, an appropriate color balance adjustment suited to the size of the subject of imaging can be performed.

E4. Third Embodiment of Image Quality Adjustment Processing

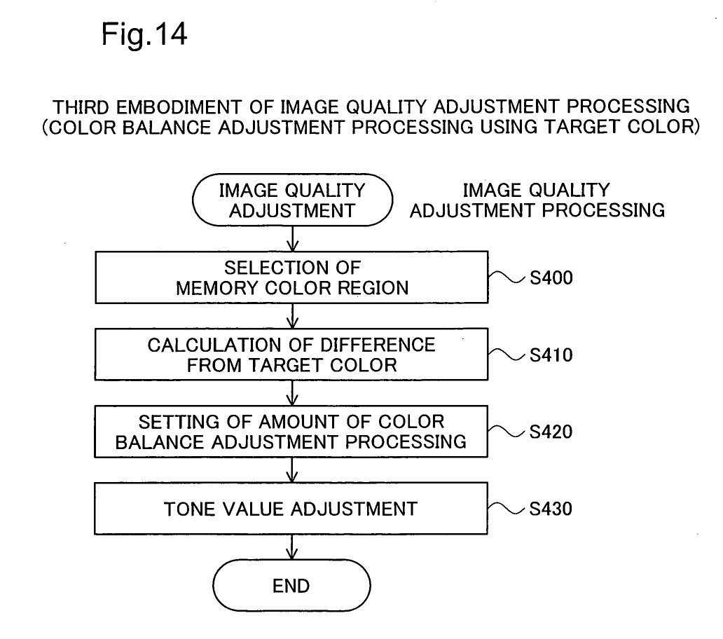

FIG. 14 is a flow chart which shows another embodiment of the image quality adjustment processing (corresponding to step S240 in FIG. 8). This embodiment differs from the embodiment shown in FIG. 9 in two respects. The first difference is that the adjustment of the processing amount of the color balance adjustment is performed in accordance with the differences between the respective color components of the memory color regions (memory color pixel groups) and the respective color components of the color that is felt to be desirable by the user (i.e., the target color) as well as the size parameter value. The other difference is that only the memory color regions are the object of color balance adjustment processing. In step S400, the CPU 41 (FIG. 7) selects the memory color regions. For example, in cases where images using persons as the subject of imaging are processed, flesh color pixels that satisfy the conditions (s1) through (s3) shown in FIG. 13(a) can be selected as memory color regions. Next, in step S410, the differences between the respective color components in the memory color regions and the respective color components of the target color are calculated using the pixel values of the memory color regions selected in step S400. The differences between the average tone values in the memory color regions and the tone values of the target color in the respective color components of RGB can be used as the above-mentioned differences (details will be described later). The tone value data for the target color is stored beforehand in a memory such as the PROM 43 (FIG. 7) or the like. Next, in step S420, the processing amount of the color balance adjustment is set on the basis of the differences of the respective color components and the size parameter value, and in step S430, color balance adjustment is performed so that the coloring of the memory color regions approaches the target color (details will be described later).

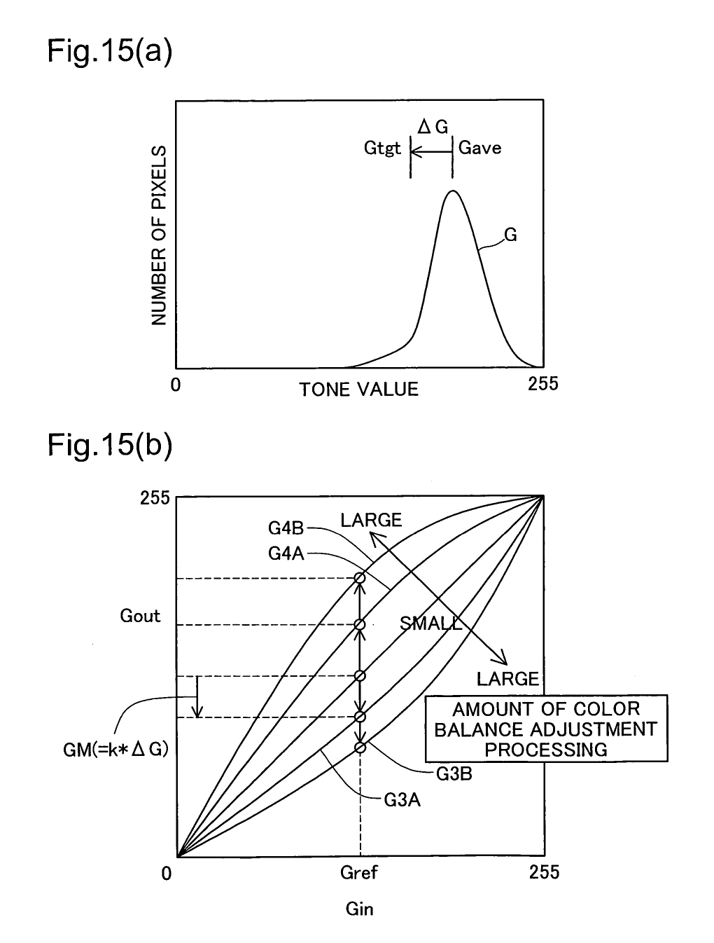

FIGS. 15(a) and 15(b) are explanatory diagrams which show the abovementioned differences and the tone value adjustment processing (color balance adjustment processing). FIG. 15(a) shows an example of the tone value distribution for green G in the memory color regions selected in step S400 (FIG. 14).

Equation 1 shown below is used to calculate the differences in the respective color components (ΔR, ΔG, ΔB) between the target color and the memory color regions in the present embodiment.
ΔR=Rtgt−Rave
ΔG=Gtgt−Gave
ΔB=Btgt−Bave [Equation 1]
Here, Rave, Gave and Bave are the average values of R, G and B in the memory color regions, and Rtgt, Gtgt and Btgt are the R, G and B values of the target color.

In the example shown in Equation 1, the differences between the RGB tone values (Rtgt, Gtgt, Btgt) of the target color and the average tone values (Rave, Gave, Bave) of the respective colors of RGB in the memory color regions are used as the differences (ΔR, ΔG, Δb) of the respective color components. In cases where there is a great difference between the hue of the memory color regions and the hue of the target color, i.e., in cases where the bias of the hue of the memory color regions from the target color is large, the RGB average tone values (Rave, Gave, Bave) of the memory color regions and the RGB tone values (Rtgt, Gtgt, Btgt) of the target color show different values. In this case, larger differences are obtained in the case of color components showing a larger deviation from the target color. In cases where the coloring of the memory color regions is closed to the target color, the RGB average tone values (Rave, Gave, Bave) of the memory color regions and the RGB tone values (Rtgt, Gtgt, Btgt) of the target color show substantially the same values for the respective color components; accordingly, small values are obtained as the differences (ΔR, ΔG, ΔB). Thus, the differences of the respective color components may also be called values that indicate differences in hue between two colors (in this example, the color of the memory color regions and the target color). In cases where there is a great difference between the hues of the two colors, large differences are obtained for the color components that have a large deviation.

FIG. 15(b) is an explanatory diagram which shows the relationship between the input level Gin and output level Gout for green G in the tone value adjustment processing of the present embodiment. This example differs from the embodiment shown in FIG. 10 in that the adjustment magnitude GM is determined on the basis of the difference AG for green G (FIG. 15(a), Equation 1) as well as the size parameter value. For example, a value obtained by multiplying the difference ΔG by a specified coefficient k can be used as such an adjustment magnitude GM. This specified coefficient k is a value that can be determined on the basis of a sensory-response evaluation of the image output results, and is a value that can be adjusted on the basis of the size parameter value (details will be described later). Furthermore, the coefficient k refers to the proportion of the processing amount of the color balance adjustment with respect to the magnitude of the difference (hereafter referred to as the “processing amount proportion”). It is not always necessary that the relationship between the difference AG and the adjustment magnitude GM be a proportional relationship; any relationship which is such that the adjustment magnitude GM increases with an increase in the difference is sufficient. If this is done, the difference can be appropriately reduced on the basis of its magnitude, so that the coloring of the memory color regions can be caused to approach the target color.

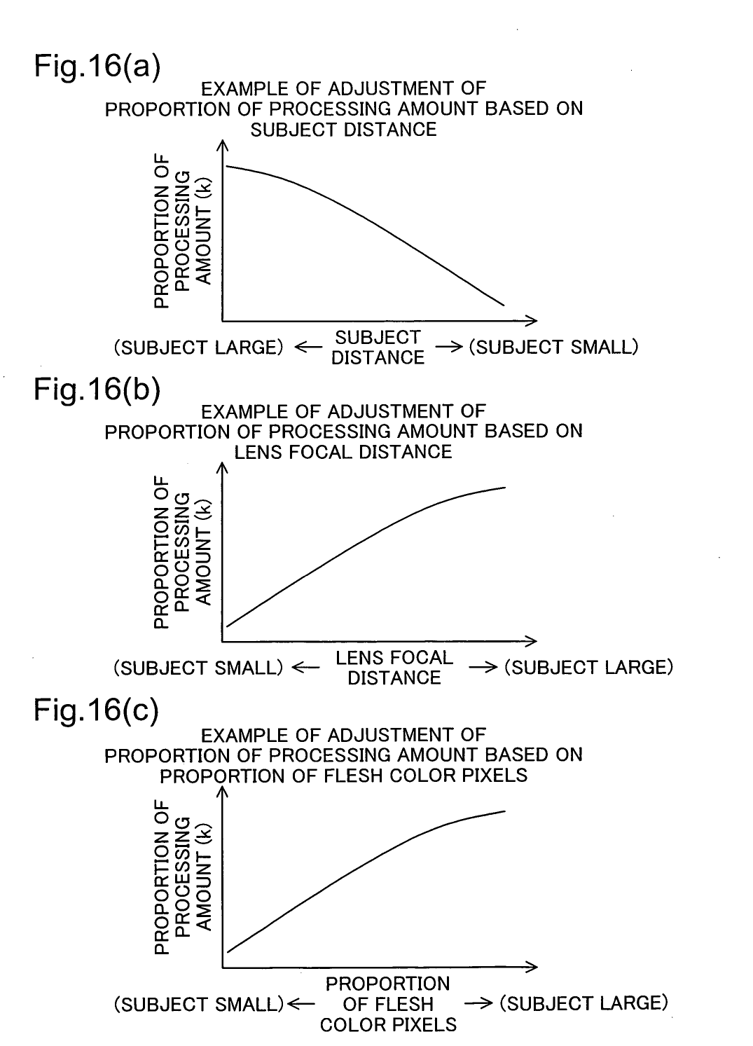

FIGS. 16(a) through 16(c) are explanatory diagrams which show the relationship between the processing amount proportion k (FIG. 15(b)) and the size parameter value. FIG. 16(a) shows the relationship between this proportion and the subject distance used as a size parameter value, FIG. 16(b) shows the relationship between this proportion and the lens focal distance used as a size parameter value, and FIG. 16(c) shows the relationship between this proportion and the proportion of the memory color pixels (proportion of the flesh color pixels in this example) used as a size parameter value. In all of these cases, an adjustment is performed so that the processing amount proportion k increases with an increase in the size of the subject of imaging indicated by the size parameter value.

If the processing amount proportion k is thus adjusted in accordance with the size of the subject of imaging, then color balance adjustment processing using a large processing amount is performed in cases where the size of the subject of imaging is large; accordingly, the coloring of conspicuous memory color regions that have a large size can be appropriately caused to approach the target color. Furthermore, in cases where the size of the subject of imaging is small, the processing amount of the color balance adjustment is reduced; accordingly, extensive destruction of the color balance between the coloring of the memory color regions and the coloring of the background can be suppressed. Furthermore, in cases where the original coloring of the memory color regions is close to the target color, i.e., in cases where the magnitudes of the differences of the respective color components are small, the processing amount set on the basis of the differences is small even in cases where the size of the subject of imaging is large; accordingly, extensive alteration of the coloring of the image data can be suppressed.

Furthermore, in this embodiment, the regions that are the object of image quality adjustment processing (processing object regions) coincide with the memory color regions; however, it is not necessary that the processing object regions and memory color regions coincide. For example, image quality adjustment using a target color may also be performed for pixels in which the difference between the hue of the pixels and the hue of the target color is equal to or less than a specified value among pixels other than the pixels of the memory color regions. In this case, it is desirable that the processing amount of the image quality adjustment be set so that this processing amount varies continuously from the processing amount in the memory color regions to the processing amount in regions outside the object of processing (i.e., zero) as the hue varies. By doing this, it is possible to suppress conspicuous boundaries between the regions where image quality adjustment is performed and regions where this adjustment is not performed. In this case, an adjustment amount obtained by applying weighting that decreases as the difference between the target color and hue increases can be used as the adjustment amount of the image quality adjustment (adjustment magnitude GM in FIG. 15(b)). Furthermore, image quality adjustment processing that uses the entire image, i.e., all of the pixels, as an object may also be performed. The conspicuousness of boundaries between regions where image quality adjustment is performed and regions where this adjustment is not performed can also be suppressed in this way.

E5. Fourth Embodiment of Image Quality Adjustment Processing

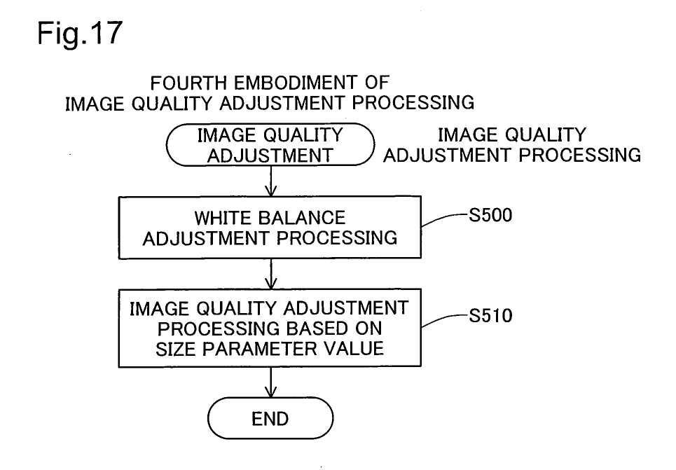

FIG. 17 is a flow chart which shows another embodiment of the image quality adjustment processing (corresponding to step S240 in FIG. 8). This embodiment differs from the respective embodiments described above (FIGS. 9 and 14) in that white balance adjustment processing (step S500) is performed prior to the color balance adjustment processing (step S510) performed on the basis of the size parameter value. In other words, this embodiment differs from the respective embodiments described above in that white balance adjustment processing is performed prior to the processing shown in FIG. 9 or FIG. 14.

This white balance adjustment processing is processing that is performed in order to reduce bias (color fogging) of the color in the image data, and is performed using the entire image as an object. The coloring (hue) of the image data is strongly affected by the light source that is used when the image data is produced. Various types of light sources such as sunlight, fluorescent lighting and the like may be used as a light source in accordance with the place and time of imaging and the preference of the user. Furthermore, the colors of these light sources vary according to the type of light source. Accordingly, even if the subject of imaging is the same, there may be cases where image data showing a deviation in color (color fogging) is produced according to the type of light source used. The degree of such color fogging can be obtained by calculating the degree of deviation of the coloring in regions that are close to achromatic. In the case of white balance adjustment processing, the tone values of the respective color components are adjusted so that such color fogging is reduced.

The white balance adjustment processing is similar to the abovementioned color balance adjustment processing in that the coloring (hue) is adjusted; for example, processing similar to the processing shown in FIG. 14 is performed. There are three differences between this white balance adjustment processing and the color balance adjustment processing shown in FIG. 14. One difference is that regions that are close to achromatic are used instead of memory color regions in order to calculate the differences of the respective color components (color fogging). Another difference is that a achromatic color is used as the target color for calculating the differences of the respective color components. Specifically, the target values of the tone values of the respective color components of RGB are equal values. The final difference is that the processing amount proportion k is a value that does not depend on the size parameter value.

For example, pixels that satisfy the conditions shown below can be used as regions that are close to achromatic.
(g1) The saturation S is equal to or less than the saturation threshold value Sth.
(g2) The brightness value L is equal to or greater than the brightness threshold value Lth.

If pixels with a small saturation S and large brightness value L are thus selected, the selection of regions with a large saturation having the color that is characteristic of the subject of imaging as regions for calculating the color differences of the respective color components can be prevented. A value determined on the basis of a sensory-response evaluation of the output results of the images can be used as the saturation threshold value Sth. For example, in cases where the range of values that can be adopted by the saturation is 0 to 1, 0.1 may be used as the threshold value. A smaller saturation threshold value makes it possible to select regions that are close to achromatic; accordingly, the effects of the vividness and hue of the color that is characteristic of the subject of imaging on the white balance adjustment processing can be suppressed to smaller effects. Furthermore, a value determined on the basis of a sensory-response evaluation of the output results of the images can be used as the brightness threshold value Lth. For example, in a case where the range of values that can be adopted by the brightness value is 0 to 255, this threshold value may be set at 180.

Equation 2 shown below is used to calculate the differences AR, AG and AB in this white balance adjustment processing.
ΔR=Lave−Rave
ΔG=Lave−Gave
ΔB=Lave−Bave [Equation 2]
Here, Rave, Gave and Bave are the average values of R, G and B in regions that are close to achromatic, and Lave is the brightness value calculated from Rave, Gave and Bave.

In the example shown in Equation 2, the differences between the average tone values Rave, Gave and Bave of the respective colors of RGB and the brightness value Lave calculated using the average tone values of the respective colors are used as the differences AR, AG and AB of the respective colors of RGB. For example, the following equation 3 for conversion from the RGB color space to the YCbCr color space can be used as the calculation formula for calculating the brightness value.
Y=L=0.299*R+0.587*G+0.114*B [Equation 3]

The brightness value Lave obtained using this equation can be called an average tone value that is calculated using differences in brightness among color components as weighting for red R, green G and blue B. In cases where the color deviation is small, the average tone values Rave, Gave and Bave for the respective color components of RGB are substantially the same value; accordingly, the brightness value, i.e., the average tone value Lave using brightness as weighting, and the average tone values Rave, Gave and Bave for the respective color components, are substantially the same value. As a result, small values are obtained as the differences AR, AG and AB for the respective color components. In cases where the color deviation is large, the average tone values Rave, Gave and Bave for the respective color components of RGB are different from each other. In this case, larger differences are obtained in the case of colors whose deviation from the brightness value Lave as a reference value is greater. Thus, by using an average tone value (brightness value), calculated using brightness that differs according to color as a weighting, as a reference value for the calculation of the differences of the respective colors, it is possible to calculate differences that are closer to the human visual sense.

The adjustment magnitude of the tone values, i.e., the color (white) balance adjustment processing amount, is determined on the basis of the differences calculated in this way. Furthermore, color fogging (differences of the respective color components) can be reduced by adjusting the tone values of the respective color components of all of the pixels in the image data on the basis of the processing amount thus obtained.

Thus, the selection of memory color regions can be performed more appropriately by performing white balance adjustment processing prior to color balance adjustment processing in accordance with the size of the subject of imaging. For example, in cases where a person is imaged under a reddish light source such as an incandescent lamp or the like, there may be instances in which reddish image data is produced. In such cases, if memory color regions (flesh color regions in the present example) are selected using the conditions shown in FIG. 13(a), there may be instances in which these regions are selected not because the redness of regions that were originally flesh color has become stronger, but rather because the redness of regions that were originally not flesh color has become stronger. If white balance adjustment processing is performed beforehand as in the present embodiment, then the performance of color balance adjustment processing using regions that are not intrinsically memory color regions can be prevented.

Furthermore, in the present embodiment, excessive adjustment of the coloring of memory color regions can also be prevented. For example, in cases where a person is imaged under a reddish light source such as an incandescent lamp or the like, there may be instances in which image data in which the skin color is reddish is produced. In such cases, if the color balance adjustment processing shown in FIG. 9 is performed, there may be instances in which the redness of the flesh color regions is further emphasized, so that the resulting coloring is undesirable. If white balance adjustment processing is performed beforehand as in the present embodiment, such excessive adjustment of the coloring can be prevented.

E6. Fifth Embodiment of Image Quality Adjustment Processing

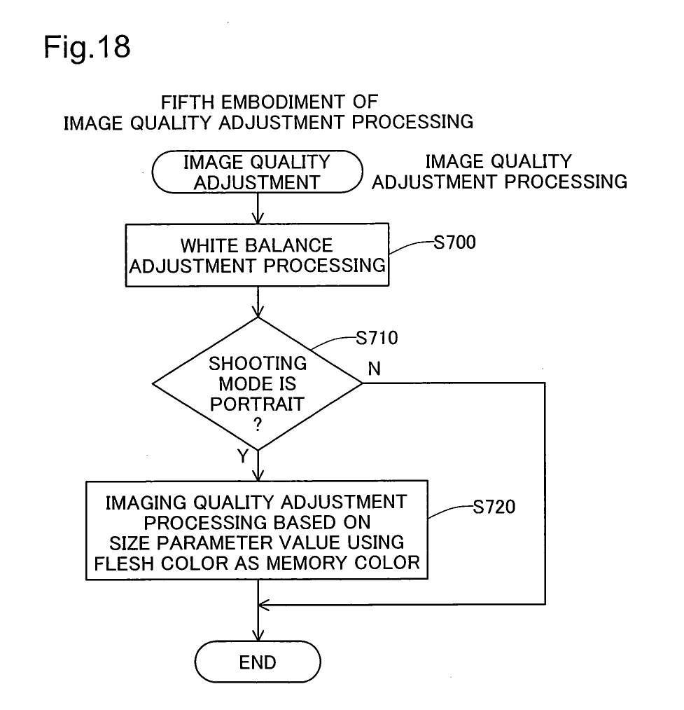

FIG. 18 is a flow chart which shows another embodiment of the image quality adjustment processing (corresponding to step S240 in FIG. 8). This embodiment differs from the respective embodiments described above (FIGS. 9, 14 and 17) in that color balance adjustment processing (step S720) is performed according to the size parameter value in cases where it is judged that the operating settings of the image producing device at the time of image data production are suited to portrait images (step S710: Y).

For example, the “shooting mode information” (FIG. 5) in the abovementioned embodiment of the image production record information can be used in order to judge whether or not the operating settings of the image producing device at the time of image data production are settings that are suitable for portrait images. The parameter value of the “shooting mode information” can be acquired by analyzing the image production record information; the set shooting mode was stored by the image producing device at the time of imaging (i.e., at the time of image data production). The shooting mode can be selected and set from a plurality of provided selection branches (mainly in accordance with the type of the subject of imaging). For example, this mode can be selected from the standard mode, portrait mode, scenery mode, night scene mode and the like. In cases where the portrait mode is set among these shooting modes, the operating settings may be judged to be settings that are suitable for portrait images.

In cases where it is judged that the operating settings are suitable for portrait images (step S710: Y), there is a high probability that the subject of imaging in the image data is a person. Accordingly, in the next step S720, color balance adjustment processing using the flesh color of a person as the memory color is performed. In this step, color balance adjustment processing is performed so that the hue of the flesh color regions used as memory color regions is adjusted to a desirable hue. The processing of the respective embodiments described above (FIG. 9 or FIG. 14) can be used as this color balance adjustment processing. Thus, in cases where the shooting mode is the portrait mode, color balance adjustment processing using the flesh color of a person as the memory color is performed; accordingly, adjustment of the coloring of flesh color regions for images in which the subject of imaging is not a person can be prevented.

F. Construction of Image Output System

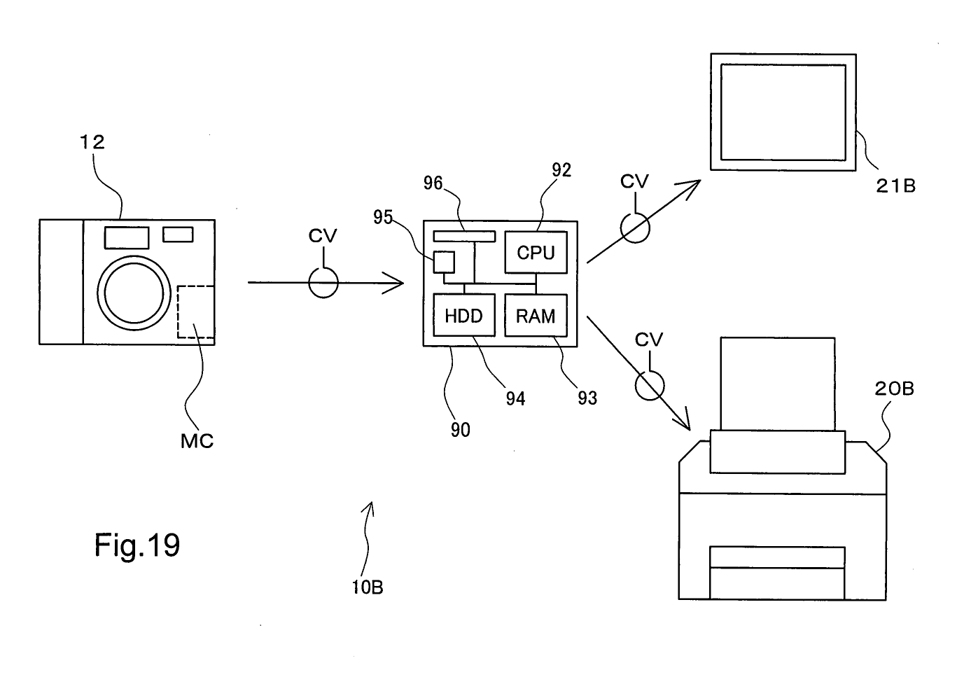

FIG. 19 is an explanatory diagram which shows one example of an image output system to which an image data processing device constituting one embodiment of the present invention can be applied. This image output system 10B comprises a digital still camera 12 as an image producing device that produces an image file, a computer 90 which performs image quality adjustment processing on the basis of this image file, and a printer 20B used as an image output device that outputs images. The computer 90 is a computer of a commonly used type, and functions as an image data processing device. Besides such a printer 20B, a monitor 21B such as a CRT display, LCD display or the like, or a projector or similar device may be used as an image output device. In the following description, a case in which a printer 20B is used as an image output device will be described. The present embodiment differs from the abovementioned embodiment of an image output system (FIG. 1) in that the image data processing device comprising an image quality adjuster and the image output device comprising an image output unit are independently constructed. Furthermore, the computer used as an image data processing device and the printer comprising an image output unit can be called “output device” in the broad sense.

The image file produced in the digital still camera 12 is sent to the computer 90 via a cable CV, or by directly inserting a memory card MC on which the image file is stored into the computer 90. The computer 90 performs image quality adjustment processing of the image data based on the image file that is read in. The image data produced by this image quality adjustment processing is sent out to the printer 20B via the cable CV, and is output by the printer 20B.

The computer 90 comprises a CPU 92 which executes a program that realizes the abovementioned image quality adjustment processing, a RAM 93 which temporarily stores the calculation results of the CPU 92, image data and the like, and a hard disk drive (HDD) 94 which stores data required for image quality adjustment processing such as image quality adjustment processing programs, memory colors and the like. The CPU 92, RAM 93 and HDD 94 function as an image quality adjuster. Furthermore, the computer 90 also comprises a memory card slot 96 used to mount memory cards MC, and an input-output terminal 95 which is used to connect a connecting cable from the digital still camera 12 or the like.

The image file GF produced by the digital still camera 12 is supplied to the computer via a cable or memory card MC. When an image retouch application or an image data processing application program called a printer driver is started by an operation performed by the user, the CPU 92 executes an image processing routine (FIG. 8) that processes the read-in image file GF. Furthermore, a construction may also be used in which the image data processing application program is automatically started as a result of the detection of the insertion of a memory card MC into the memory card slot 96, or the connection of the digital still camera 12 to the input-output terminal 95 via a cable.

In this embodiment, the image data processed by the CPU 92 is sent out to an image output device, e.g., the printer 20B, instead of being output in step S250 of the image processing routine (FIG. 8), and the output of images is performed by the image output device that has received this image data.

In the present invention, since image processing is performed by an image quality adjuster provided in the computer 90, an image output device that does not have an image quality adjuster can be used. Furthermore, in cases where the image output device has an image quality adjuster, a construction may be used in which the computer 90 sends the image data out to the image output device without performing image processing, and image processing is performed by the image quality adjuster of the image output device.

Thus, in the respective embodiments described above, color balance adjustment processing is performed in accordance with a size parameter value that relates to the size of the subject of imaging in the image data. Accordingly, output results with a high image quality which have been subjected to an appropriate image quality adjustment in accordance with the size of the subject of imaging can easily be obtained.

Furthermore, the present invention is not limited to the abovementioned embodiments or working configurations. The present invention may be worked in various aspects within limits that involve no departure from the spirit of the invention; for example, the following modifications are possible.

G. Modifications

G1. Modification 1

In the respective embodiments described above, information in which a distance range is set as a parameter value, e.g., the subject distance range (FIG. 5), may be used as subject distance information that relates to the distance between the image producing device and the subject of imaging in the image data. In this case, it is desirable that typical distances be preset for respective distance ranges, and that color balance adjustment processing be performed in accordance with these typical distances. For example, in the case of distance ranges for which an upper limit value and lower limit value of the distance are set, an intermediate value can be used as the typical distance, and in the case of distance ranges for which only an upper limit value or lower limit value is set, this upper limit value or lower limit value can be used.

G2. Modification 2

In the respective embodiments described above, the adjustment magnitude of the color balance adjustment (FIGS. 11 and 13) and the processing amount proportion k (FIG. 16) vary continuously with the variation of the size parameter value; however, these values may also be set so that the values vary stepwise in a plurality of stages. Furthermore, in ranges in which the size of the subject of imaging indicated by the size parameter value is small, the adjustment amount and processing amount proportion may be set at zero, i.e., may be set so that color balance adjustment processing is not performed.

G3. Modification 3

The memory color is not limited to flesh color in cases where persons are used as objects of imaging; this color can be set in accordance with regions that tend to be noticed by the human eye, such as the blue color of the sky, the green color of mountains or the like. In any case, high-quality output results in which the coloring of the memory color regions is desirable can be obtained by performing color balance adjustment processing in accordance with the size of the subject of imaging that has the memory color. Furthermore, it is desirable that a non-white color be set as the memory color.

G4. Modification 4

In the abovementioned embodiments, a case was described in which a file with an Exif format was used as a concrete example of the image file GF. However, the format of the image file of the present invention is not limited to this. Specifically, any image file that contains image data produced in the image producing device and image production record information GI that describes the shooting conditions at the time of the production of the image data may be used. If such a file is used, the image quality of the image data produced in the image producing device can be automatically adjusted in an appropriate manner, and the image data can then be output from an output device.

G5. Modification 5

In the abovementioned embodiments, a case in which image data GD and image production record information GI were contained in the same image file GF was described as an example. However, it is not always necessary that the image data GD and image production record information GI be stored in the same file. Specifically, it is sufficient if the image data GD and image production record information GI are associated. For example, it would also be possible to produce associating data that associates the image data GD and image production record information GI, to store one or a plurality of sets of image data GD and image production record information GI in independent files, and to refer to the associated image production record information GI when the image data GD is processed. The reason for this is as follows: namely, in such cases, although the image data GD and image production record information GI are stored in separate files, the image data GD and image production record information GI are in an integral inseparable relationship at the point in time of the image processing that utilizes the image production record information GI, so that the function is substantially the same as in a case in which the two types of data are stored in the same file. Specifically, an aspect in which the image data GD and image production record information GI are associated at least at the point in time of the image processing is included in the image file of the present embodiment. Furthermore, motion image files stored on optical disk media such as CD-ROM, CD-R, DVD-ROM, DVD-RAM and the like are also included.

The present invention was described in detail and graphically illustrated above. However, these descriptions were merely indicated as examples, and do not limit the present invention. The concept and scope of the present invention are limited only by the appended claims.

1. An image processing method for processing an image using image data produced by an image producing device, and image production record information which includes at least information relating to shooting conditions at the time of production of the image data, and which is associated with the image data, the method comprising the steps of:
(a) determining a size parameter value that relates to a size of a subject in the image based on at least one of the image data and the image production record information; and
(b) performing color balance adjustment processing of the image data based on the size parameter value.

2. An image processing method according to claim 1, wherein the color balance adjustment processing is performed for the entirety of the image.

3. An image processing method according to claim 1, wherein the step (a) includes the step of selecting subject distance information obtained from the image production record information as the size parameter value in cases where the image production record information includes the subject distance information relating to a distance between the image producing device and the subject of the image data at the time of the production of the image data.

4. An image processing method according to claim 1, wherein the step (a) includes the step of selecting lens focal distance information obtained from the image production record information as the size parameter value in cases where the image production record information includes the lens focal distance information relating to a lens focal distance of the image producing device at the time of the production of the image data.

5. An image processing method according to claim 1, wherein the step (a) includes the steps of:
calculating a proportion of pixels that have a color close to a preset memory color by analyzing the image data; and
selecting the proportion as the size parameter value.

6. An image processing method according to claim 1, wherein the step (b) includes the step of adjusting a processing amount of the color balance adjustment so that the processing amount increases with an increase in the size of the subject indicated by the size parameter value.

7. An image processing method according to claim 1, wherein the step (b) includes the steps of:
(i) determining magnitudes of differences of respective color components of pixels that have colors close to the preset memory color from respective color components of a preset target color in the image data by analyzing the image data; and
(ii) adjusting a processing amount of the color balance adjustment in accordance with the magnitudes of the differences;
and wherein the step (ii) includes the step of adjusting a proportion of the processing amount of the color balance adjustment with respect to the magnitudes of the differences so that the proportion is increased as the size of the subject indicated by the size parameter value increases.

8. An image processing method according to claim 1, wherein the method further comprises the steps of:
judging whether or not operating settings of the image producing device at the time of the production of the image data are suitably set for portrait images by analyzing the image production record information in cases where the image production record information includes shooting mode information relating to the operating settings; and
performing the step (b) in cases where the judgment is affirmative.

9. An image processing device for processing an image using image data produced by an image producing device, and image production record information which includes at least information relating to shooting conditions at the time of production of the image data, and which is associated with the image data, the image processing device comprising:
an image quality adjuster which determines a size parameter value that relates to a size of a subject in the image based on at least one of the image data and the image production record information, and which performs color adjustment balance processing of the image data based on the size parameter value.

10. A computer program product which is used to process an image using image data produced by an image producing device and image production record information which includes at least information relating to shooting conditions at the time of production of the image data, and which is associated with the image data, the computer program product comprising:
a computer-readable medium; and
a computer program stored on the computer-readable medium;
wherein the computer program includes a program for causing a computer to implement a function which determines a size parameter value that relates to a size of a subject in the image based on at least one of the image data and the image production record information, and which performs color balance adjustment processing of the image data based on the size parameter value.

11. An image output device for outputting an image using image data produced by an image producing device, and image production record information which includes at least information relating to shooting conditions at the time of production of the image data, and which is associated with the image data, the image output device comprising:
an image quality adjuster which can determine a size parameter value that relates to a size of a subject in the image based on at least one of the image data and the image production record information, and which can perform color balance adjustment processing of the image data based on the size parameter value; and
an output unit which outputs an image using the image data whose image quality has been adjusted.
